(19) United States
(12) Patent Application Publication
(10) Pub. No.: US 2007/0074810 A1
(43) Pub. Date: Apr. 5, 2007

(54) Laminating apparatus and laminating process

(75) Inventor: Chih-Tsung Kao, Taipei (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Primax Electronics Ltd.

(21) Appl. No.: 11/271,636

(22) Filed: Nov. 10, 2005

(30) Foreign Application Priority Data
Sep. 30, 2005 (TW) 094134222

(51) Int. Cl. B32B 37/10; C09J 5/00; B32B 37/00; B30B 15/34; B32B 37/08

(52) U.S. Cl. 156/311; 156/580; 156/583.1; 156/498; 156/312

(57) ABSTRACT

A laminating apparatus includes a pressing passage and a heating member. The pressing passage includes first and second passage zones. A combination structure including an adhesive film and an article is fed to the pressing passage via an inlet thereof, and successively passes through the first passage zone and the second passage zone of the pressing passage. A first pressing and heating operation and a second pressing operation of the combination structure are respectively performed during the periods of passing through the first passage zone and the second passage zone to form a laminated combination structure, which is detached from the pressing passage via an outlet thereof. The heating member is disposed in the vicinity of the inlet of the pressing passage and over the first passage zone to provide heat required for performing the first pressing and heating operation of the combination structure.

### FIELD OF THE INVENTION

The present invention relates to a laminating apparatus and a laminating process, and more particularly to a laminating apparatus and a laminating process for laminating a sheet article with an adhesive film by performing a pressing and heating operation and then another pressing operation, thereby preventing the laminate from getting jammed in the laminating apparatus.

### BACKGROUND OF THE INVENTION

Conventionally, a sheet article such as a paper, a card or the like is usually covered with an adhesive film for protection because this protecting approach is simple and cost effective. For example, laminating apparatuses are widely used for laminating a sheet article. The persons skilled in the art made their efforts to develop suitable laminating apparatus for smoothly and effectively laminating the sheet article.

Please refer to FIG. 1, which schematically illustrates a sheet article 10 to be laminated with an adhesive film 11. The adhesive film 11 includes an upper film layer 111 and a lower film layer 112 with adhesive materials 113 and 114 on the surfaces facing to each other. An entrance structure is defined between the upper film layer 111 and the lower film layer 112. Via the entrance structure, the sheet article 10 is sandwiched between the upper film layer 111 and the lower film layer 112. After the sandwich structure is pressed and heated by the laminating apparatus 20 as shown in FIGS. 2(A) and 2(B), the sheet article 10 is firmly bonded to the adhesive film 11.

Alternatively, the conventional adhesive film 11 may have only one adhesive material coated on either of the upper film layer 111 and the lower film layer 112. The principle of laminating the sheet article 10 with such adhesive film 11 is similar to that shown in FIG. 1, and is not to be redundantly described herein.

Referring to FIGS. 2(A) and 2(B), schematic perspective and side views of a conventional laminating apparatus 20 are respectively illustrated. The laminating apparatus 20 comprises a pair of cylindrical rollers 22 and 23. Each of the rolling surfaces of these rollers 22 and 23 is sheathed around an elastic silicone layer. The left ends of the cylindrical rollers 22 and 23 are fixed on a roller holder 21. The right ends 222 and 232 of the cylindrical rollers 22 and 23 are fixed on another roller holder (not shown). In order to heat and soften the adhesive materials 113 and 114 of the adhesive film 11, the upper and lower portions of the cylindrical rollers 22 and 23 are partially enclosed with an upper heating element 24 and a lower heating element 25, respectively. The mechanism for driving the cylindrical rollers 22 and 23, the principle of generating heat by the upper heating element 24 and the lower heating element 25, and the structure of the housing (not shown) of the laminating apparatus 20 are well known in the art, and not to be redundantly described herein.

The process for laminating the sheet article 10 with the adhesive film 11 will be described as follows. Firstly, the sandwich structure of the adhesive film 11 and the sheet article 10 is fed to the laminating apparatus 20 in the direction indicated by the arrow I, and then pressed by the rolling surfaces of the cylindrical rollers 22 and 23. Meanwhile, the adhesive materials 113 and 114 of the adhesive film 11 are heated and softened by the heat generated from the upper heating element 24 and the lower heating element 25. Afterward,.the sandwich structure is continuously advanced and thermally pressed, to bond the sheet article 10 with the adhesive film 11, and then detached from the laminating apparatus in the direction indicated by the arrow O.

The above-mentioned laminating apparatus 20 shown in FIGS. 2(A) and 2(B) has several drawbacks. For example, the sandwich structure of the adhesive film 11 and the sheet article 10 is readily bent toward upwardly or downwardly due to the heat generated from the upper heating element 24 and the lower heating element 25. Therefore, after passing through the rolling surfaces of the cylindrical rollers 22 and 23, the laminated sandwich structure may be jammed in the gap 26 between the upper heating element 24 and the cylindrical rollers 22 or jammed in the gap 27 between the lower heating element 25 and the cylindrical rollers 23. Under this circumstance, the cylindrical rollers 22 and 23 will get stuck and fail to rotate. In addition, the laminated sandwich structure may be distorted or deformed.

In views of the above-described disadvantages resulted from the conventional product, the applicant keeps on carving unflaggingly to develop a laminating apparatus and a laminating process according to the present invention through wholehearted experience and research.

### SUMMARY OF THE INVENTION

It is an object of the present invention to provide a laminating process for preventing the laminated sheet article from getting jammed in the laminating apparatus.

It is another object of the present invention to provide a laminating apparatus for preventing the laminated sheet article from getting jammed in the pressing mechanism thereof.

In accordance with a first aspect of the present invention, there is provided a laminating apparatus. The laminating apparatus comprises a pressing passage and a heating member. The pressing passage includes first and second passage zones. A combination structure including an adhesive film and an article is fed to the pressing passage via an inlet thereof, and successively passes through the first passage zone and the second passage zone of the pressing passage. A first pressing and heating operation and a second pressing operation of the combination structure are respectively performed during the periods of passing through the first passage zone and the second passage zone to form a laminated combination structure, which is detached from the pressing passage via an outlet thereof. The heating member is disposed in the vicinity of the inlet of the pressing passage and over the first passage zone to provide heat required for performing the first pressing and heating operation of the combination structure.

Preferably, the article of the combination structure is a sheet article.

In an embodiment, the first passage zone has a first starting point in the vicinity of the inlet of the pressing passage and a first terminal point communicated with a second starting point of the second passage zone, and the second passage zone further has a second terminal point in the vicinity of the outlet of the pressing passage.

In an embodiment, the pressing passage is defined between a first pressing member and a second pressing member from first sides to second sides of the first and second pressing members.

In an embodiment, the first and second pressing members are first and second conveyor assemblies, respectively. Each of the first and second conveyor assemblies comprises two cylindrical rollers, which are separated from each other by a certain distance, enclosed by a flexible belt, and respectively disposed in the vicinity of the inlet and the outlet of the passage zone. The lower rectangular surface of the first conveyor assembly and the upper rectangular surface of the second conveyor assembly serve as the pressing surfaces, which are faced to each other and cooperatively define the pressing passage.

In an embodiment, the first pressing and heating operation is performed during the combination structure passes through the first passage zone by pressing the combination structure with the first and second conveyor assemblies and simultaneously heating the combination structure with the heating member.

In an embodiment, the heating member comprises at least a heating element disposed in the vicinity of the inlet of the pressing passage and partially enclosing the first and second conveyor assemblies. Alternatively, the heating member is disposed within the cylindrical rollers in the vicinity of the inlet of the pressing passage.

In an embodiment, the second pressing operation is performed during the combination structure passes through the second passage zone by pressing the combination structure with the first and second conveyor assemblies.

In an embodiment, a cooling operation is performed during the combination structure passes through the second passage zone by cooling the combination structure with a cooling mechanism.

In an embodiment, the cooling mechanism includes a cooling plate disposed in the vicinity of the outlet of the pressing passage and partially enclosing the first and second conveyor assemblies. Alternatively, the cooling mechanism is disposed within the cylindrical rollers in the vicinity of the outlet of the pressing passage.

In an embodiment, the laminating apparatus further comprises a confining member for confining the flexible belts in position by suppressing the flexible belts to be in close contact with the cylindrical rollers.

In an embodiment, the confining member comprises at least a cylindrical rod, which has at least a rod end stopped by an arc-shaped stopping block protruded from a roller holder and a main body sustained against the upper surface of the first conveyor assembly or the lower surface of the second conveyor assembly.

Alternatively, the confining member comprises an elongated indentation structure with a semicircular cross-section and at least two resilient supporting parts. The lower ends of the resilient supporting parts are accommodated within the elongated indentation structure. The bottom of the elongated indentation structure is sustained against the upper surface of the first conveyor assembly or the lower surface of the second conveyor assembly. Preferably, each resilient supporting part comprises a protrusion post partially accommodated in the elongated indentation structure and a spiral spring sheathed around the protrusion post.

Alternatively, the confining member comprises at least a spiral spring, which has two ring-shaped buckles at both ends thereof and hooked around a fixed post protruding from a roller holder and a shaft of a cylindrical roller, respectively.

Alternatively, the confining member includes at least a first teeth structure arranged on the inner surface of the flexible belt of the first or second conveyor assembly, and the corresponding cylindrical roller has a second teeth structure engaging with the first teeth structure.

In accordance with a second aspect of the present invention, there is provided a laminating apparatus. The laminating apparatus comprises a pressing mechanism and a heating member. The pressing mechanism includes first and second pressing members for pressing a combination structure including an adhesive film and an article. Specially, at least one of the first and second pressing members is a conveyor assembly, and the first pressing member cooperates with the second pressing member for transferring the combination structure from first sides to second sides of the first and second pressing members and laminating the adhesive film with the article to form a laminated combination structure. The heating member is disposed in the vicinity of the first sides of the first and second pressing members for heating and softening the adhesive film when the adhesive film is laminated to the article.

In accordance with a third aspect of the present invention, there is provided a laminating process. First of all, a combination structure including an adhesive film and an article is provided. Then, the combination structure is fed to an inlet of a pressing passage of a laminating apparatus. The combination structure is allowed to successively pass through a first passage zone and a second passage zone of the pressing passage and be detached from an outlet of the pressing passage. Consequently, a laminated combination structure is formed. Specially, a first pressing and heating operation and a second pressing operation are performed during the combination structure passes through the first passage zone and the second passage zone of the pressing passage, respectively.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates a sheet article to be laminated with an adhesive film;

FIGS. 2(A) and 2(B) are schematic perspective and side views illustrating a conventional laminating apparatus, respectively;

FIG. 3 is a schematic perspective view of a laminating apparatus according to a first preferred embodiment of the present invention;

FIGS. 4(A) and 4(B) are schematic perspective and side views illustrating a laminating apparatus according to a second preferred embodiment of the present invention, respectively;

FIGS. 5(A) and 5(B) are schematic perspective and side views illustrating a laminating apparatus according to a third preferred embodiment of the present invention, respectively;

FIGS. 6(A) and 6(B) are schematic perspective and side views illustrating a laminating apparatus according to a fourth preferred embodiment of the present invention, respectively;

FIGS. 7(A) and 7(B) are schematic perspective and side views illustrating a laminating apparatus according to a fifth preferred embodiment of the present invention, respectively; and

FIG. 8 is a flowchart illustrating a laminating process according to a preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

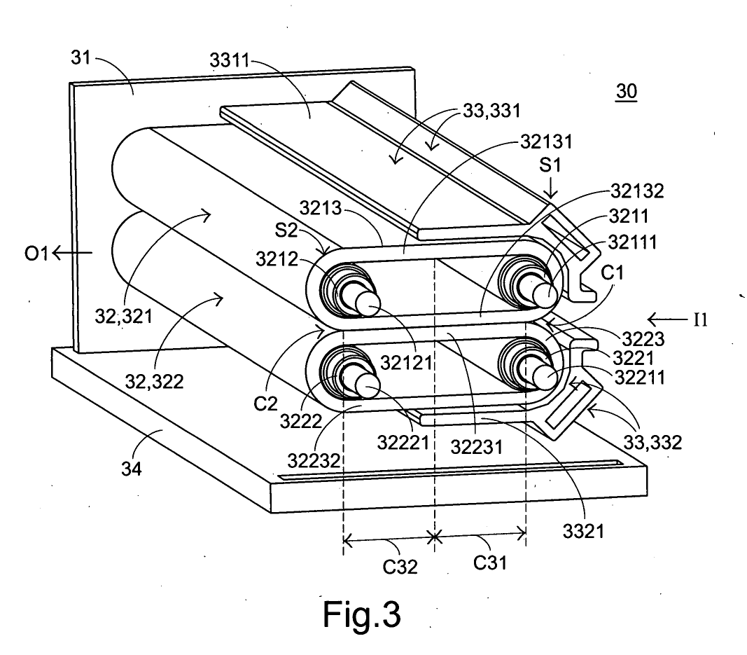

Referring to FIG. 3, a schematic perspective view of a laminating apparatus according to a preferred embodiment of the present invention is illustrated. The laminating apparatus 30 of FIG. 3 principally comprises a roller holder 31, a pressing mechanism 32, a heating member 33 and a base 34. The mechanism for driving the pressing mechanism 32, the principle of generating heat by the heating member 33, and the structure of the housing (not shown) of the laminating apparatus 30 are well known in the art, and not to be redundantly described herein.

The pressing mechanism 32 comprises a first pressing member 321 and a second pressing member 322. A first passage zone C31 and a second passage zone C32 are defined between the first pressing member 321 and the second pressing member 322 from the first sides S1 of the pressing members 321 and 322 to the second sides S2 of the pressing members 321 and 322. Preferably, the terminal point of the first passage zone C31 is communicated with the starting point of the second passage zone C32 to form a continuous pressing passage.

In this embodiment, the first pressing member 321 comprises two cylindrical rollers 3211 and 3212, which are separated from each other by a certain distance and enclosed by a flexible belt 3213. The cylindrical rollers 3211 and 3212 are disposed in the vicinity of the inlet C1 and the outlet C2 of the pressing passage, respectively. The flexible belt 3213 is stretched with the cylindrical rollers 3211 and 3212, so that the first pressing member 321 is substantially a first conveyor assembly including the flexible belt 3213 and the cylindrical rollers 3211 and 3212. Likewise, the second pressing member 322 comprises two cylindrical rollers 3221 and 3222, which are separated from each other by a certain distance and enclosed by a flexible belt 3223. The cylindrical rollers 3221 and 3222 are also disposed in the vicinity of the inlet C1 and the outlet C2 of the pressing passage, respectively. The flexible belt 3223 is stretched with the cylindrical rollers 3221 and 3222, so that the second pressing member 322 is substantially a second conveyor assembly including the flexible belt 3223 and the cylindrical rollers 3221 and 3222. The lower rectangular surface 32132 of the first conveyor assembly 321 and the upper rectangular surface 32231 of the second conveyor assembly 322 are referred as pressing surfaces, which are faced to each other and cooperatively define the pressing passage. The left ends of the shafts of the cylindrical rollers 3211, 3212, 3221 and 3222 are fixed on the roller holder 31. The right ends 32111, 32121, 32211 and 32221 of the shafts of the cylindrical rollers 3211, 3212, 3221 and 3222 are fixed on another roller holder (not shown).

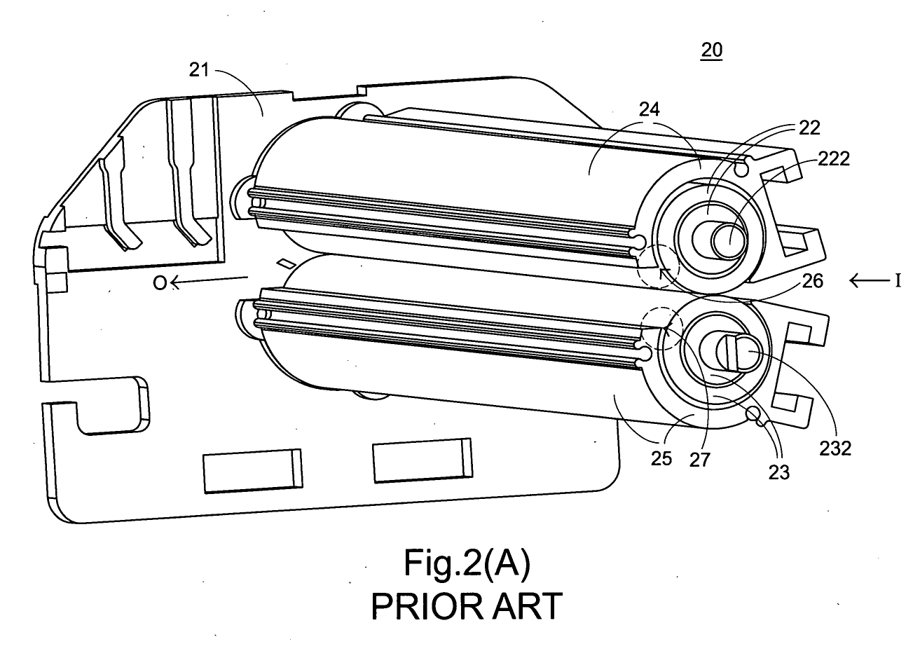

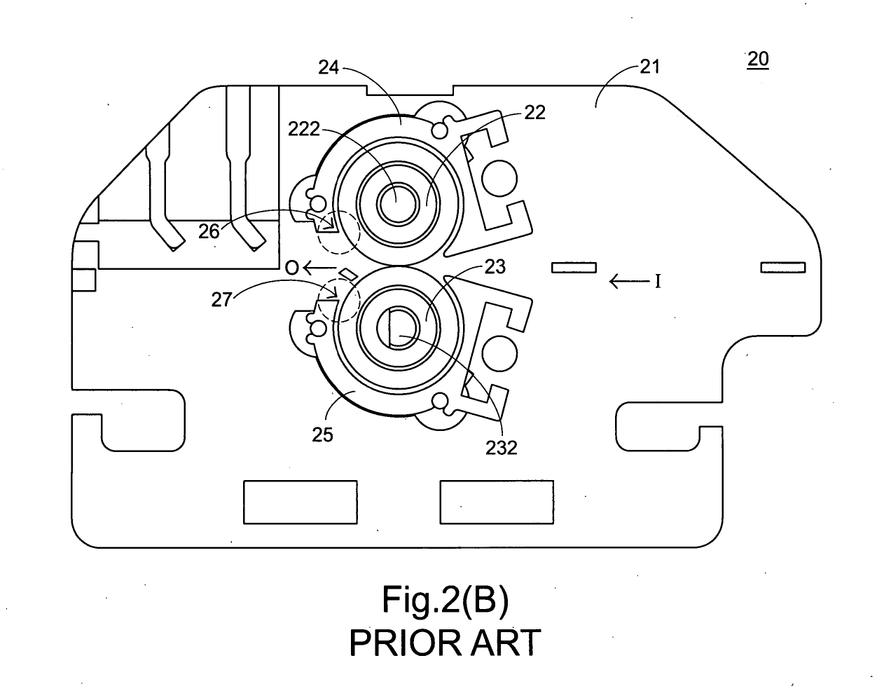

It is noted that, however, those skilled in the art will readily observe that numerous modifications and alterations of the pressing mechanism 32 may be made while retaining the teachings of the invention. For example, the pressing mechanism 32 may include only one of the conveyor assemblies 321 and 322, but the other conveyor assembly is replaced with a flat plate (not shown). Alternatively, the pressing mechanism 32 may include only one conveyor assembly 321 or 322, but the other conveyor assembly is replaced with a cylindrical roller 22 or 23 as shown in FIG. 2. Accordingly, the above disclosure should be limited only by the bounds of the following claims.

The heating member 33 of the laminating apparatus 30 comprises two heating elements 331 and 332, for example heating plates, disposed in the vicinity of the inlet C1. The first conveyor assembly 321 and the second conveyor assembly 322 in the vicinity of the inlet C1 are partially enclosed by the heating elements 331 and 332, respectively. For a purpose of enhancing heat dissipation, the upper surface 32131 of the first conveyor assembly 321 and the lower surface 32232 of the second conveyor assembly 322 are also partially enclosed by the extension parts 3311 and 3321 of the heating elements 331 and 332, respectively. It is preferred that the extension parts 3311 and 3321 are longer than or equal to the length of the first passage zone C31, but shorter than the whole pressing passage. Alternatively, the heating elements 331 and 332 may be disposed within the cylindrical rollers 3211 and 3221, respectively.

The numbers, locations or structures of the heating elements in the above embodiment are not limited to the precise forms disclosed. Unless specifically stated, it is intended to cover various modifications and similar arrangements included within the spirit and scope of the appended claims.

The process for laminating the sheet article 10 with the adhesive film 11 will be described as follows. Firstly, the sandwich structure of the adhesive film 11 and the sheet article 10 is fed to the inlet C1 of the laminating apparatus 30 in the direction indicated by the arrow I. By rolling the first conveyor assembly 321 and the second conveyor assembly 322, the sandwich structure is introduced into the pressing passage defined between the lower rectangular surface 32132 of the first conveyor assembly 321 and the upper rectangular surface 32231 of the second conveyor assembly 322. During the period of passing through the first passage zone C31, the sandwich structure is simultaneously pressed and heated by the conveyor assemblies 321 and 322 and the heating elements 331 and 332. During the sandwich structure passes through the second passage zone C32, only the pressing operation is performed. Afterward, the laminated sandwich structure is detached from the outlet C2 of the pressing passage in the direction indicated by the arrow O. Due to the simultaneous heating and pressing operations performed in the first passage zone C31 and an additional pressing operation (without heating operation) performed in the second passage zone C32, the problem of causing a bent laminate as is usually happened in the prior art will be effectively overcome. Furthermore, the possibility of jamming the laminate in the pressing mechanism is also minimized.

Alternatively, the laminating apparatus 30 of the present invention may further include a cooling mechanism (not shown) disposed in the vicinity of the outlet C2 of the pressing passage. An example of the cooling mechanism includes a cooling plate. By means of the cooling mechanism, the sandwich structure passing through the second passage zone C32 will be cooled, so that the possibility of causing a bent laminate is largely reduced. The location of the cooling mechanism may be outside the conveyor assemblies 321 and 322, or otherwise inside the cylindrical rollers 3212 and/or 3222.

In order to prevent the flexible belts 3213 and 3223 of the conveyor assemblies 321 and 322 from elastic fatigue, the laminating apparatus 30 may further include a confining member to facilitate stretching the flexible belts 3213 and 3223. The detailed description related to the confining member will be illustrated with referred to the further embodiments. By the way, unless specifically stated, the pressing mechanism, the heating members and even the cooling mechanism used in the following embodiments are similar to those shown in FIG. 3, and are not to be redundantly described herein.

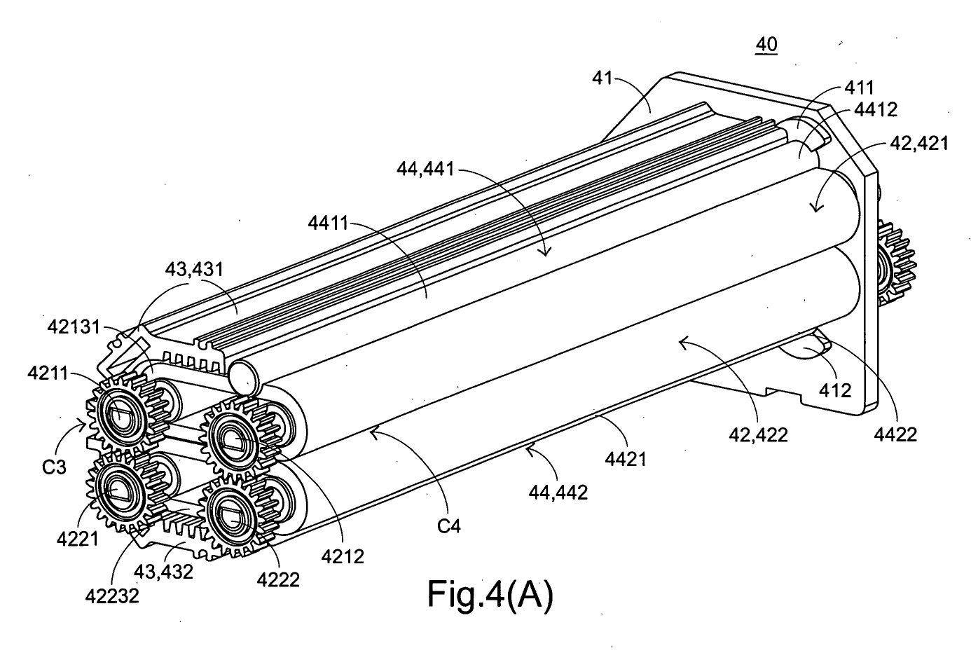

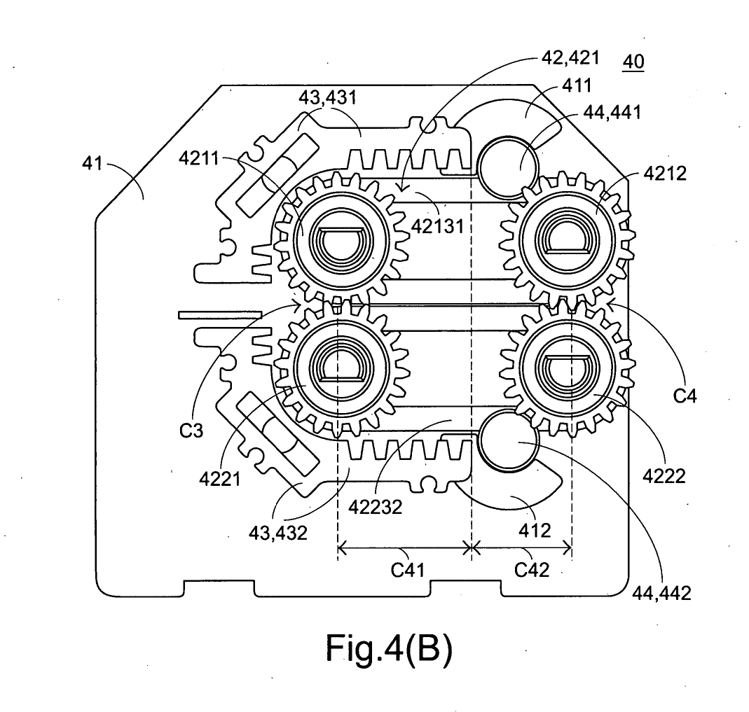

Referring to FIGS. 4(A) and 4(B), schematic perspective and side views of a laminating apparatus according to a second preferred embodiment of the present invention are respectively illustrated. The laminating apparatus 40 of FIGS. 4(A) and 4(B) principally comprises a roller holder 41, a pressing mechanism 42 and a heating member 43. The pressing mechanism 42 comprises a first conveyor assembly 421 and the second conveyor assembly 422. A first passage zone C41 and a second passage zone C42 are defined between the first conveyor assembly 421 and the second conveyor assembly 422. Preferably, the terminal point of the first passage zone C41 is communicated with the starting point of the second passage zone C42 to form a continuous pressing passage. The heating member 43 comprises two heating elements 431 and 432 disposed in the vicinity of the inlet C3. The first conveyor assembly 421 and the second conveyor assembly 422 in the vicinity of the inlet C3 are partially enclosed by the heating elements 431 and 432, respectively. For a purpose of enhancing heat dissipation, the upper surface 42131 of the first conveyor assembly 421 and the lower surface 42232 of the second conveyor assembly 422 are also partially enclosed by the extension parts of the heating elements 431 and 432, respectively. It is preferred that the extension parts are longer than or equal to the length of the first passage zone C41, but shorter than the whole pressing passage. Afterward, the laminated sandwich structure is detached from the laminating apparatus 40 via the outlet C4 of the pressing passage.

Moreover, the laminating apparatus 40 further comprises a confining member 44 for confining the flexible belts in position by suppressing the flexible belts to be in close contact with the cylindrical rollers. The confining member 44 of FIGS. 4(A) and 4(B) comprises a first cylindrical rod 441 and a second cylindrical rod 442. An arc-shaped stopping block 411 is protruded from the roller holder 41 to stop a rod end 4412 of the first cylindrical rod 441. The main body 4411 of the first cylindrical rod 441 is sustained against the upper surface 42131 of the first conveyor assembly 421. Likewise, another arc-shaped stopping block 412 is protruded from the roller holder 41 to stop a rod end 4422 of the second cylindrical rod 442. The main body 4421 of the first cylindrical rod 442 is sustained against the lower surface 42232 of the second conveyor assembly 422.

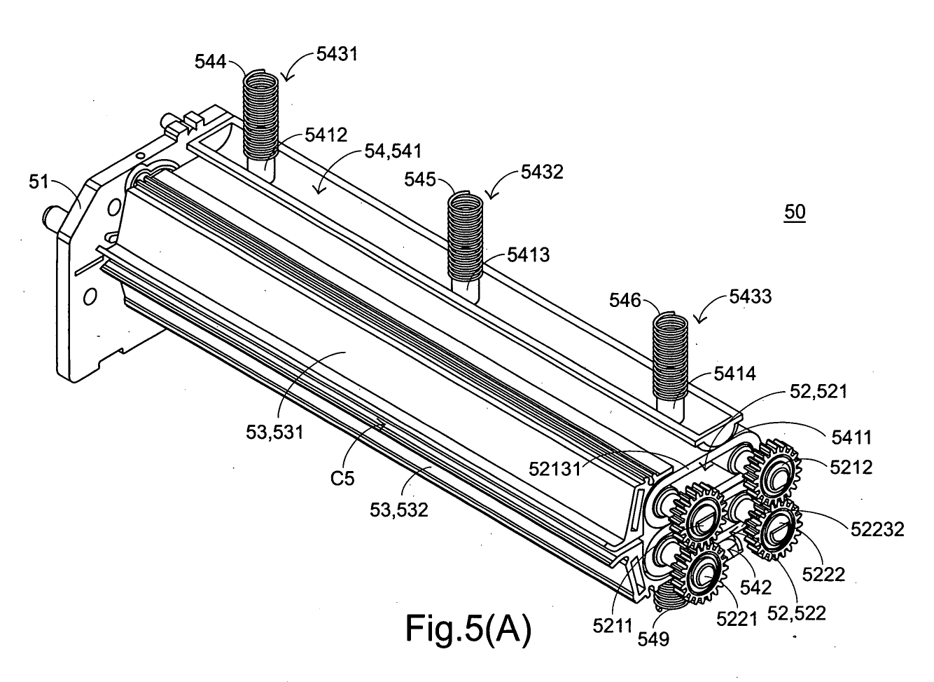

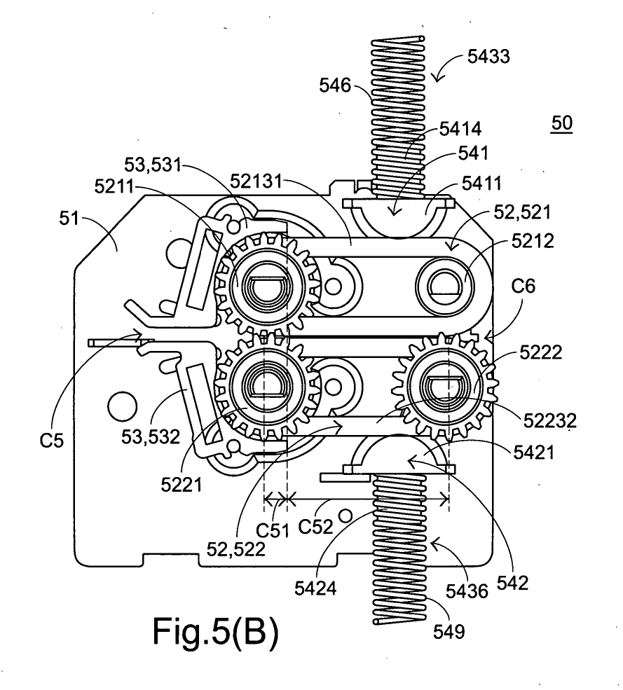

Referring to FIGS. 5(A) and 5(B), schematic perspective and side views of a laminating apparatus according to a third preferred embodiment of the present invention-are respectively illustrated. The laminating apparatus 50 of FIGS. 5(A) and 5(B) principally comprises a roller holder 51, a pressing mechanism 52 and a heating member 53. The pressing mechanism 52 comprises a first conveyor assembly 521 and the second conveyor assembly 522. A first passage zone C51 and a second passage zone C52 are defined between the first conveyor assembly 521 and the second conveyor assembly 522. Preferably, the terminal point of the first passage zone C51 is communicated with the starting point of the second passage zone C52 to form a continuous pressing passage. The heating member 53 comprises two heating elements 531 and 532 disposed in the vicinity of the inlet C5. The first conveyor assembly 521 and the second conveyor assembly 522 in the vicinity of the inlet C5 are partially enclosed by the heating elements 531 and 532, respectively. For a purpose of enhancing heating performance, the upper surface 52131 of the first conveyor assembly 521 and the lower surface 52232 of the second conveyor assembly 522 are also partially enclosed by the extension parts of the heating elements 531 and 532, respectively. It is preferred that the extension parts are longer than or equal to the length of the first passage zone C51, but shorter than the whole pressing passage. Afterward, the laminated sandwich structure is detached from the laminating apparatus 50 via the outlet C6 of the pressing passage.

Moreover, the laminating apparatus 50 further comprises a confining member 54 for confining the flexible belts in position by suppressing the flexible belts to be in close contact with the cylindrical rollers. The confining member 54 of FIGS. 5(A) and 5(B) comprises an elongated indentation structure 541 with a semicircular cross-section, and three resilient supporting parts 5431, 5432 and 5433. The three resilient supporting parts 5431, 5432 and 5433 comprise corresponding protrusion posts 5412, 5413 and 5414 and corresponding spiral springs 544, 545 and 546, respectively. The lower ends of the protrusion posts 5412, 5413 and 5414 are separately accommodated in the elongated indentation structure 541. The spiral springs 544, 545 and 546 are respectively sheathed around the protrusion posts 5412, 5413 and 5414 and sustained between the elongated indentation structure 541 and an upper housing (not shown). The bottom portion 5411 of the elongated indentation structure 541 is sustained against the upper surface 52131 of the first conveyor assembly 521.

The confining member 54 further comprises another elongated indentation structure 542 with a semicircular cross-section, and three resilient supporting parts. For purposes of clarity, only one resilient supporting part 5436 is shown in FIG. 5(B). The resilient supporting part 5436 comprises a protrusion post 5424 and a spiral springs 549. The lower end of the protrusion post 5424 is accommodated in the elongated indentation structure 542. The spiral spring 549 is respectively sheathed around the protrusion post 5424 and sustained between the elongated indentation structure 543 and a lower housing (not shown). The bottom portion 5421 of the elongated indentation structure 541 is sustained against the upper surface 52131 of the first conveyor assembly 521.

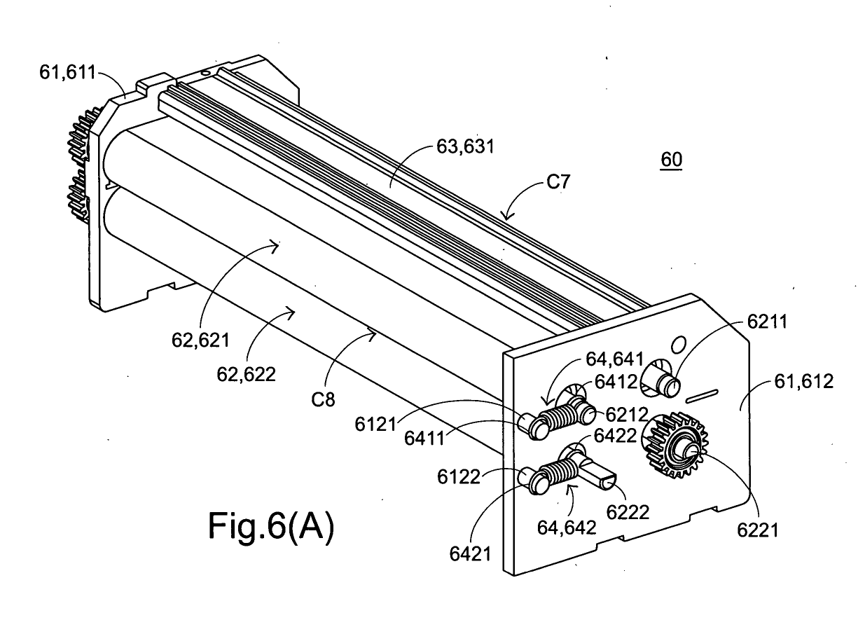

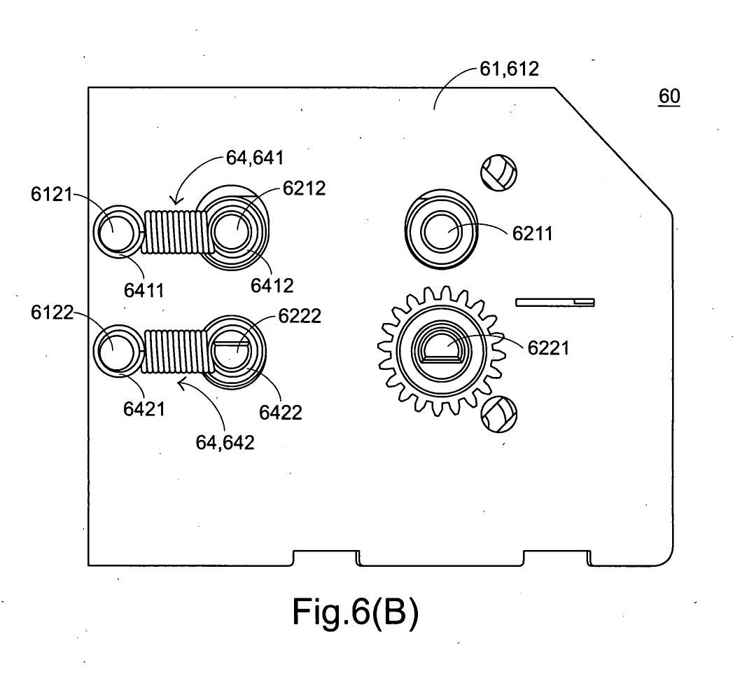

Referring to FIGS. 6(A) and 6(B), schematic perspective and side views of a laminating apparatus according to a fourth preferred embodiment of the present invention are respectively illustrated. The laminating apparatus 60 of FIGS. 6(A) and 6(B) principally comprises a roller holder member 61 including first and second roller holders 611 and 612, a pressing mechanism 62 and a heating member 63. In the embodiment, the first conveyor assembly 621, the second conveyor assembly 622 and the cylindrical rollers 6211, 6212, 6221, 6222 of the pressing mechanism 62, the first and second passage zones of the pressing passage, the inlet C7 and the outlet C8 of the pressing passage included in FIGS. 6(A) and 6(B) are similar to those shown in the above embodiments, and are not to be redundantly described herein.

Moreover, the laminating apparatus 60 further comprises a confining member 64 for confining the flexible belts in position by suppressing the flexible belts to be in close contact with the cylindrical rollers. The confining member 64 comprises two spiral springs 641 and 642. The spiral spring 641 has two ring-shaped buckles 6411 and 6412 at both ends thereof. The ring-shaped buckles 6411 and 6412 are hooked around a fixed post 6121 protruding from the second roller holder 612 and a shaft of the cylindrical rollers 6212, respectively. Likewise, the spiral spring 642 also has two ring-shaped buckles 6421 and 6422 at both ends thereof. The ring-shaped buckles 6421 and 6422 are hooked around a fixed post 6122 protruding from the second roller holder 612 and a shaft of the cylindrical rollers 6222, respectively. Similarly, the structure of the first roller holder 611 is similar to that of the second roller holder 612, and the confining member 64 further comprises two spiral springs with ring-shaped buckles (not shown) to be fixed on first roller holder 611.

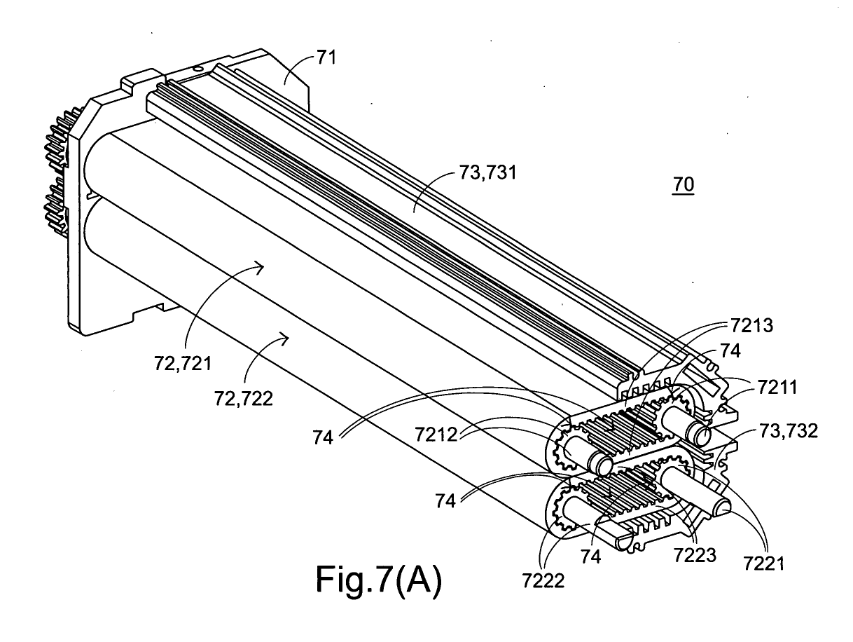

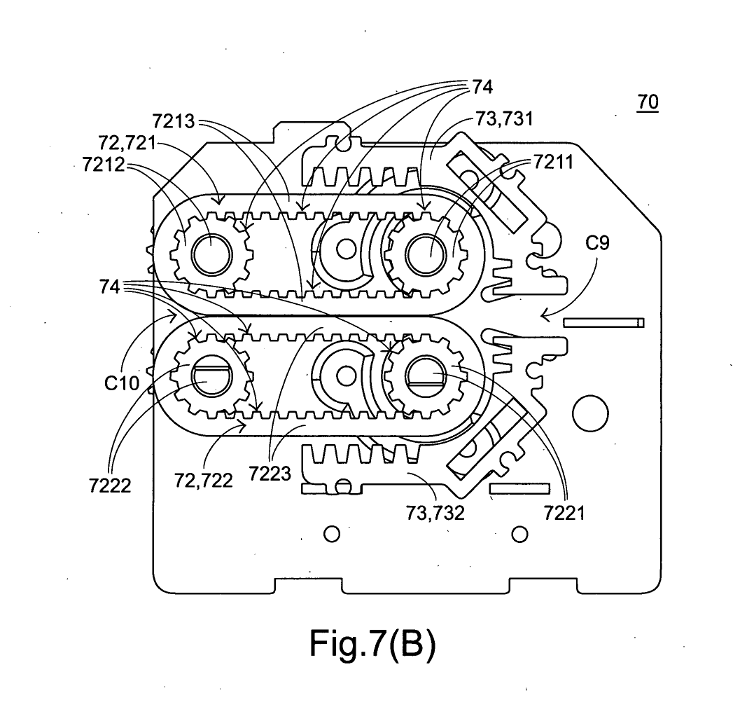

Referring to FIGS. 7(A) and 7(B), schematic perspective and side views of a laminating apparatus according to a fifth preferred embodiment of the present invention are respectively illustrated. The laminating apparatus 70 of FIGS. 7(A) and 7(B) principally comprises a roller holder 71, a pressing mechanism 72 and a heating member 73. In the embodiment, the first conveyor assembly 721, the second conveyor assembly 722 and the cylindrical rollers 7211, 7212, 7221, 7222 of the pressing mechanism 72, the first and second passage zones of the pressing passage, the inlet C9 and the outlet C10 of the pressing passage included in FIGS. 7(A) and 7(B) are similar to those shown in the above embodiments, and are not to be redundantly described herein.

Moreover, the laminating apparatus 70 further comprises a confining member 74 for confining the flexible belts in position by suppressing the flexible belts to be in close contact with the cylindrical rollers. The confining member 74 includes the teeth structures arranged on the inner surfaces of the flexible belts 3213 and 3223. The cylindrical rollers 7211, 7212, 7221 and 7222 also have complementary teeth structures engaging with the teeth structures arranged on the inner surfaces of the flexible belts 3213 and 3223.

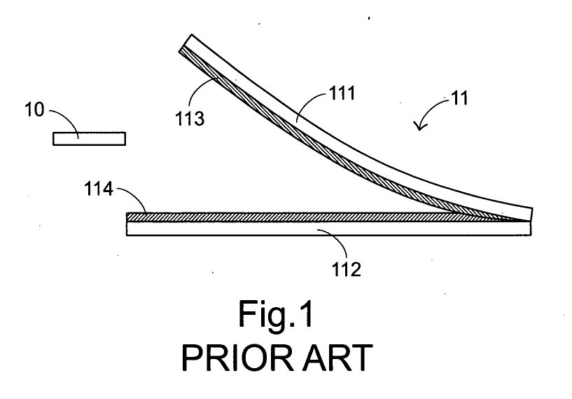

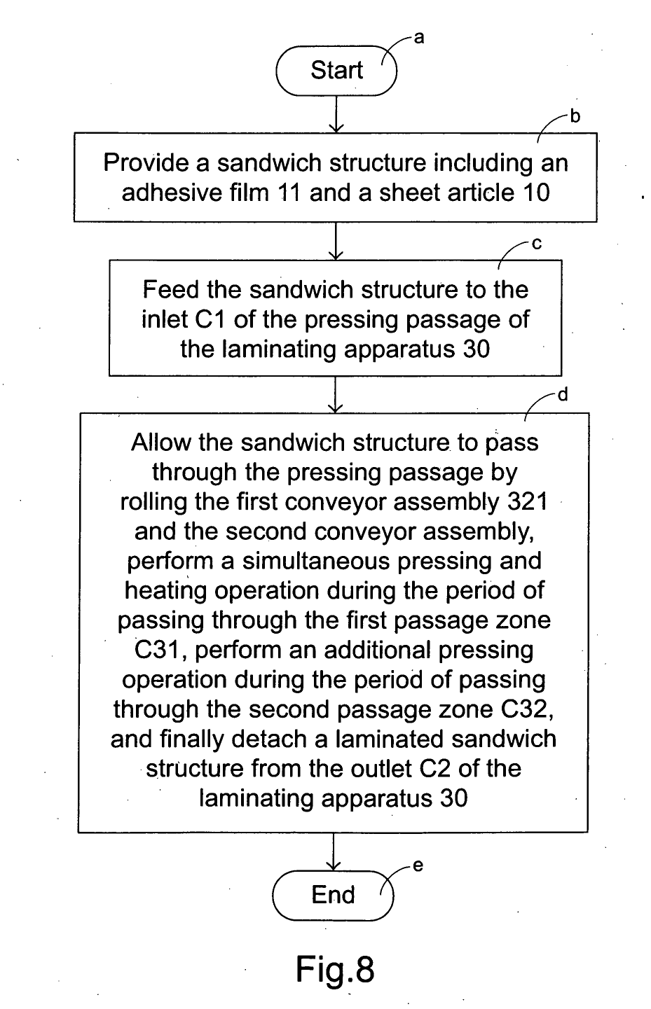

Hereinafter, a flowchart of a laminating process according to an embodiment the present invention will be illustrated with reference to FIG. 8 and also FIGS. 1 and 3.

After the laminating process is started (Step a), a sandwich structure including an adhesive film 11 and a sheet article 10 is provided (Step b). Then, the sandwich structure is fed to the inlet C1 of the pressing passage of the laminating apparatus 30 (Step c). Then, in Step (d), the sandwich structure is introduced into the pressing passage by rolling the first conveyor assembly 321 and the second conveyor assembly, a simultaneous pressing and heating operation is performed during the period of passing through the first passage zone C31, an additional pressing operation is performed during the period of passing through the second passage zone C32, and finally a laminate of the sandwich structure is detached from the outlet C2 of the laminating apparatus 30. Meanwhile, the laminating process is completed (Step e).

The above embodiments are illustrated by referring to the sandwich structure in which the sheet article 10 is sandwiched between upper and lower film layers of the adhesive film 11. Nevertheless, the present invention can be applied to any combination structure of a sheet article 10 and an adhesive film 11. For example, the sheet article 10 overlies or underlies the adhesive film 11.

From the above description, the laminating apparatus and the laminating process of the present invention are capable of offering an enhanced pressing force to laminate the sheet article with the adhesive film, so that the adverse effect resulted from the thermal treatment is reduced. Accordingly, the problem of causing a bent laminate as is usually happened in the prior art will be effectively overcome. Furthermore, the possibility of jamming the laminate in the pressing mechanism is also minimized.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A laminating apparatus comprising:
a pressing passage including first and second passage zones, a combination structure including an adhesive film and an article being fed to said pressing passage via an inlet thereof and successively passing through said first passage zone and said second passage zone of said pressing passage, wherein a first pressing and heating operation and a second pressing operation of said combination structure are respectively performed during the periods of passing through said first passage zone and said second passage zone to form a laminated combination structure, which is detached from said pressing passage via an outlet thereof; and
a heating member disposed in the vicinity of said inlet of said pressing passage and over said first passage zone to provide heat required for performing said first pressing and heating operation of said combination structure.

2. The laminating apparatus according to claim 1 wherein said article of said combination structure is a sheet article.

3. The laminating apparatus according to claim 1 wherein said first passage zone has a first starting point in the vicinity of said inlet of said pressing passage and a first terminal point communicated with a second starting point of said second passage zone, and said second passage zone further has a second terminal point in the vicinity of said outlet of said pressing passage.

4. The laminating apparatus according to claim 1 wherein said pressing passage is defined between a first pressing member and a second pressing member from first sides to second sides of said first and second pressing members.

5. The laminating apparatus according to claim 4 wherein said first and second pressing members are first and second conveyor assemblies, respectively, and each of said first and second conveyor assemblies comprises two cylindrical rollers, which are separated from each other by a certain distance, enclosed by a flexible belt, and respectively disposed in the vicinity of said inlet and said outlet of said passage zone, wherein the lower rectangular surface of said first conveyor assembly and the upper rectangular surface of said second conveyor assembly serve as said pressing surfaces, which are faced to each other and cooperatively define said pressing passage.

6. The laminating apparatus according to claim 5 wherein said first pressing and heating operation is performed during said combination structure passes through said first passage zone by pressing said combination structure with said first and second conveyor assemblies and simultaneously heating said combination structure with said heating member.

7. The laminating apparatus according to claim 6 wherein said heating member comprises at least a heating element disposed in the vicinity of said inlet of said pressing passage and partially enclosing said first and second conveyor assemblies, or disposed within said cylindrical rollers in the vicinity of said inlet of said pressing passage.

8. The laminating apparatus according to claim 5 wherein said second pressing operation is performed during said combination structure passes through said second passage zone by pressing said combination structure with said first and second conveyor assemblies.

9. The laminating apparatus according to claim 5 wherein a cooling operation is performed during said combination structure passes through said second passage zone by cooling said combination structure with a cooling mechanism.

10. The laminating apparatus according to claim 9 wherein said cooling mechanism includes a cooling plate disposed in the vicinity of said outlet of said pressing passage and partially enclosing said first and second conveyor assemblies, or disposed within said cylindrical rollers in the vicinity of said outlet of said pressing passage.

11. The laminating apparatus according to claim 5 further comprising a confining member for confining said flexible belts in position by suppressing the flexible belts to be in close contact with the cylindrical rollers.

12. The laminating apparatus according to claim 11 wherein said confining member comprises at least a cylindrical rod, which has at least a rod end stopped by an arc-shaped stopping block protruded from a roller holder and a main body sustained against the upper surface of said first conveyor assembly or the lower surface of said second conveyor assembly.

13. The laminating apparatus according to claim 11 wherein said confining member comprises an elongated indentation structure with a semicircular cross-section and at least two resilient supporting parts, the lower ends of said resilient supporting parts are accommodated within said elongated indentation structure, and the bottom of said elongated, indentation structure is sustained against the upper surface of said first conveyor assembly or the lower surface of said second conveyor assembly.

14. The laminating apparatus according to claim 13 wherein each resilient supporting part comprises a protrusion post partially accommodated in said elongated indentation structure and a spiral spring sheathed around said protrusion post.

15. The laminating apparatus according to claim 11 wherein said confining member comprises at least a spiral spring, which has two ring-shaped buckles at both ends thereof and hooked around a fixed post protruding from a roller holder and a shaft of a cylindrical roller, respectively.

16. The laminating apparatus according to claim 11 wherein said confining member includes at least a first teeth structure arranged on the inner surface of said flexible belt of said first or second conveyor assembly, and said corresponding cylindrical roller has a second teeth structure engaging with said first teeth structure.

17. A laminating apparatus comprising:
a pressing mechanism including first and second pressing members for pressing a combination structure including an adhesive film and an article, wherein at least one of said first and second pressing members is a conveyor assembly, and said first pressing member cooperates with said second pressing member for transferring said combination structure from first sides to second sides of said first and second pressing members and laminating said adhesive film with said article to form a laminated combination structure; and
a heating member disposed in the vicinity of said first sides of said first and second pressing members for heating and softening said adhesive film when said adhesive film is laminated to said article.

18. A laminating process comprising steps of:
providing a combination structure including an adhesive film and an article;
feeding said combination structure to an inlet of a pressing passage of a laminating apparatus; and
allowing said combination structure to successively pass through a first passage zone and a second passage zone of said pressing passage and be detached from an outlet of said pressing passage, thereby forming a laminated combination structure, wherein a first pressing and heating operation and a second pressing operation are performed during said combination structure passes through said first passage zone and said second passage zone of said pressing passage, respectively.

19. The laminating process according to claim 18 wherein said first passage zone has a first starting point in the vicinity of said inlet of said pressing passage and a first terminal point communicated with a second starting point of said second passage zone, and said second passage zone further has a second terminal point in the vicinity of said outlet of said pressing passage.

20. The laminating process according to claim 18 wherein said pressing passage is defined between a first pressing member and a second pressing member from first sides to second sides of said first and second pressing members.

21. The laminating process according to claim 20 wherein said first and second pressing members are first and second conveyor assemblies, respectively, and each of said first and second conveyor assemblies comprises two cylindrical rollers, which are separated from each other by a certain distance, enclosed by a flexible belt, and respectively disposed in the vicinity of said inlet and said outlet of said passage zone.

22. The laminating process according to claim 21 wherein said first pressing and heating operation is performed during said combination structure passes through said first passage zone by pressing said combination structure with first and second conveyor assemblies and simultaneously heating said combination structure with said heating member.

23. The laminating process according to claim 22 wherein said heating member comprises at least a heating element disposed in the vicinity of said inlet of said pressing passage and partially enclosing said first and second conveyor assemblies, or disposed within said cylindrical rollers in the vicinity of said inlet of said pressing passage.

24. The laminating process according to claim 21 wherein said second pressing operation is performed during said combination structure passes through said second passage zone by pressing said combination structure with first and second conveyor assemblies.

25. The laminating process according to claim 21 wherein a cooling operation is performed during said combination structure passes through said second passage zone by cooling said combination structure with a cooling mechanism.

26. The laminating process according to claim 25 wherein said cooling mechanism includes a cooling plate disposed in the vicinity of said outlet of said pressing passage and partially enclosing said first and second conveyor assemblies, or disposed within said cylindrical rollers in the vicinity of said outlet of said pressing passage.
